(19) United States
(12) Patent Application Publication
(10) Pub. No.: US 2015/0280496 A1
(43) Pub. Date: Oct. 1, 2015

(54) Improved Shaped Metallic Element for Making Laminations and Lamination Obtained by Joining a Plurality of Said Improved Shaped Metallic Elements

(71) Applicant: VECO S.P.A., Bevilacqua (VR) (IT)

(72) Inventor: Piergiuseppe Concato, Arzignano (IT)

(73) Assignee: VECO S.P.A., Bevilacqua (VR) (IT)

(21) Appl. No.: 14/225,046

(22) Filed: Mar. 25, 2014

(51) Int. Cl. H02K 1/16; H01F 41/02; H01F 27/26; H02K 1/26; H01F 27/245

(52) U.S. Cl. CPC H02K 1/16; H02K 1/26; H01F 27/245; H01F 27/263; H01F 41/0206

(57) ABSTRACT

A shaped metallic element (1) for making laminations (100) of a stator (200) and/or a rotor (300) of a rotary electric machine (400) or for making the laminated ferromagnetic core (500) of a static electric machine, including two sides (2, 3) suited to be fixedly joined to corresponding sides (2, 3) of two shaped metallic elements (1) arranged so that they are adjacent to said shaped metallic element (1). In the shaped metallic element (1) the two sides (2, 3) have a shaped profile (4) matching the shaped profile of the sides (2, 3) of the adjacent shaped metallic elements (1) so that the shaped metallic elements (1) can be fixedly coupled with each other through interference.

### CROSS-REFERENCE TO RELATED APPLICATIONS

Not applicable.

### BACKGROUND OF THE INVENTION

1. The Field of the Invention

The invention concerns a shaped metallic element suited to be coupled, at the level of at least two of its sides, with the corresponding sides of shaped metallic elements arranged so that they are adjacent to it, in such a way as to obtain laminations for making stators and/or rotors of rotary electric machines or for making laminated ferromagnetic cores of static electric machines.

The invention also concerns a lamination obtained by joining a plurality of said shaped metallic elements.

Furthermore, the invention concerns the rotor, the stator or the laminated ferromagnetic core obtained by stacking a plurality of said laminations of the invention, the rotary electric machine comprising said stator and/or said rotor arranged coaxially with each other and the static electric machine comprising said laminated ferromagnetic core.

Finally, the invention concerns the method and two types of apparatus suited to make the lamination by means of said shaped metallic elements.

2. The Relevant Technology

It is known that rotary electric machines, used both as motors for generating movement and as electric energy generators, are substantially constituted by a fixed hollow portion, called stator, with a cylindrical portion, called rotor and connected to the rotation shaft, rotating inside it.

It is also known that static electric machines, in particular transformers, comprise a laminated ferromagnetic core of the column or mantle type.

To make the stator and the rotor of a rotary electric machine or the laminated ferromagnetic core of a static electric machine special elements made of a metallic material are stacked on one another, said elements having a thickness in the order of a few tenths of a millimetre and being called laminations L in technical jargon, and an example of said elements being shown in FIG. 1 that illustrates the state of the art.

In order to be able to stack the laminations L in a stable manner for the purpose of making the stator, the rotor or the laminated ferromagnetic core, the same laminations L are secured to one another using special connection techniques like, for example, die-casting, riveting, welding or other equivalent processes.

It is also known that in most cases said laminations L are obtained from foils M made of a metallic material, which are subjected to a pressing process carried out by means of special pressing devices.

In particular, the most known and most used techniques for making the laminations L comprise a pressing process of the so-called type by steps or stages.

Using these techniques, in fact, it is possible to obtain laminations L made in a single body, in a shape corresponding to the shape of the stator, the rotor or the ferromagnetic core to be obtained.

However, as extensively described in the Italian patent application no. VI2008A000159, filed by the same applicant, said techniques used to obtain said laminations L disadvantageously pose the drawback of involving a considerable waste of metallic material.

In fact, as can be observed in FIG. 2, which illustrates the known art and shows a process for making a stator by steps, the angular ends E and the centre portion C of each rectangular element Q of the metallic foil M, from which the same laminations L are obtained, are not exploited and consequently they become unused scrap material that can be possibly recovered through a founding process.

For this reason, the above mentioned patent application no. VI2008A000159 has the purpose of reducing the amount of scrap material produced while pressing the laminations L, and intends to obtain, on the same pieces of material that were previously considered scrap, shaped metallic elements that when joined to one another make it possible to obtain laminations that can be used to make the stator and the rotor of an “exciting device”.

The exciting device is provided with a rotor and a stator, used to power the electromagnets arranged on the main rotor of an alternator.

In particular, according to the technique proposed by the above mentioned patent application, the various shaped metallic elements are joined to one another by welding.

To disadvantage, as explained above, the laminations obtained in this way are only suited to be used for making the stator and/or the rotor of an exciting device, and not also for making the main stator and rotor of a rotary electric machine or for making the ferromagnetic core of a static electric machine. This happens because the welding technique used to join the various shaped metallic elements causes, in the connection area, a magnetic flux loss that is not negligible and can reach 50% compared to a lamination made in a single body.

Therefore, to disadvantage, the use of the laminations obtained in this way to make the main stators and rotors of rotary electric machines or to make the ferromagnetic cores of static electric machines would involve a high loss of efficiency of the same machines, thus making said laminations clearly unsuitable for that purpose.

The present invention intends to overcome the drawbacks described above.

In particular, it is the object of the invention to provide shaped metallic elements that, when joined to one another, make it possible to obtain laminations whose efficiency is just a few percentage points lower than that of the laminations made in a single body.

For this reason, it is the object of the present invention to provide shaped metallic elements that make it possible to obtain laminations that can be used to make the main stator and/or rotor of a rotary electric machine and the laminated ferromagnetic core of a static electric machine.

It is another object of the present invention to obtain the shaped metallic elements from portions of a metallic foil that were previously considered scrap material.

Consequently, it is the object of the present invention to provide shaped metallic elements that make it possible to reduce the costs involved when making the rotors, the stators and the laminated ferromagnetic cores of rotary and static electric machines, respectively.

The objects described above are achieved by a shaped metallic element having the characteristics described in the main claim.

In particular, the shaped metallic element that is the subject of the invention is characterized in that it has at least two sides with matching shaped profile so that they can be coupled through interference with the corresponding sides with matching shaped profile of shaped metallic elements arranged so that they are adjacent to the metallic element itself

Advantageously, said solution makes it possible to reduce to a minimum the magnetic flux loss in the connection area, and thus to slightly vary the efficiency compared to the laminations obtained in a single body.

Further characteristics of the shaped metallic elements are described in the dependent claims.

The invention includes also the lamination obtained by joining a plurality of said shaped metallic elements, the rotor, the stator and the laminated ferromagnetic core obtained by stacking a plurality of said laminations and finally the rotary electric machine and the static electric machine respectively comprising at least said rotor or at least said stator and said laminated ferromagnetic core.

Finally, the invention also includes the method and two types of apparatus for making the lamination using said shaped metallic elements.

### BRIEF DESCRIPTION OF THE DRAWINGS

The objects and advantages described above will be highlighted in greater detail in the description of a preferred embodiment of the invention that is provided here below by way of non-limiting example with reference to the attached drawings, wherein:

FIG. 1 shows a lamination carried out according to the known art obtained in a single body and used to make the main stator of a rotary electric machine;

FIG. 2 shows the pressing technique of the known art used to obtain a lamination in a single body starting from a foil made of a metallic material;

FIG. 3 shows the shaped metallic element of the invention according to a first embodiment;

FIG. 4 shows the shaped metallic element of the invention according to a second embodiment;

FIG. 5 shows a lamination of the invention obtained by coupling through interference a plurality of shaped metallic elements of the invention;

FIG. 6 shows the stator of the invention obtained by stacking a plurality of laminations of the invention;

FIG. 7 shows the rotor of the invention obtained by stacking a plurality of laminations of the invention;

FIG. 8 shows the rotary electric machine comprising at least the stator and/or at least the rotor of the invention;

FIG. 9 shows the laminated ferromagnetic core of the invention obtained by stacking a plurality of laminations of the invention;

FIG. 10 shows a template on which a plurality of shaped metallic elements of the shaped element of FIG. 3 is arranged in such a way as to define the shape of the stator to be obtained;

FIG. 11 shows a top view of the apparatus for making the laminations of the invention;

FIG. 12 shows an axonometric view of the first type of apparatus for making the laminations of the invention;

FIG. 13 shows the cross section of a first axonometric view of the loading unit belonging to the first type of apparatus for making the laminations of the invention;

FIG. 14 shows the cross section of a second axonometric view of the loading unit belonging to the first type of apparatus for making the laminations of the invention;

FIG. 15 shows a view from below of the first rotary plane belonging to the loading unit of the first type of apparatus for making the laminations of the invention;

FIG. 16 shows a top view of a processing unit of the first type of apparatus for making the laminations of the invention;

FIG. 17 shows an axonometric view of the rotary plane belonging to the second type of apparatus for making the laminations of the invention;

FIG. 18 shows a top view of the rotary plane belonging to the second type of apparatus for making the laminations of the invention;

FIG. 19 shows an axonometric view of the rotary plane and of the conveyors of the second type of apparatus for making the laminations of the invention.

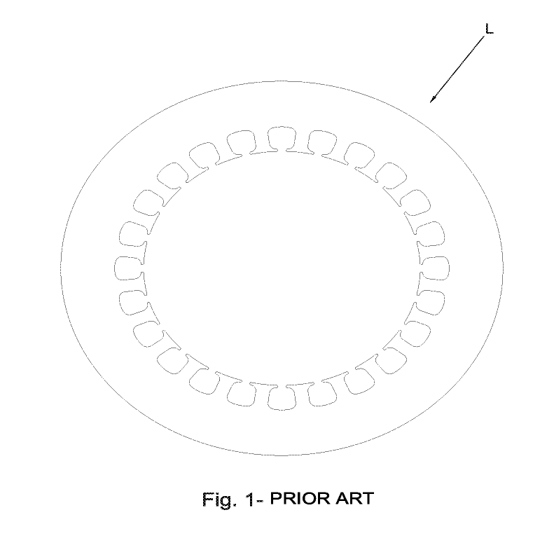

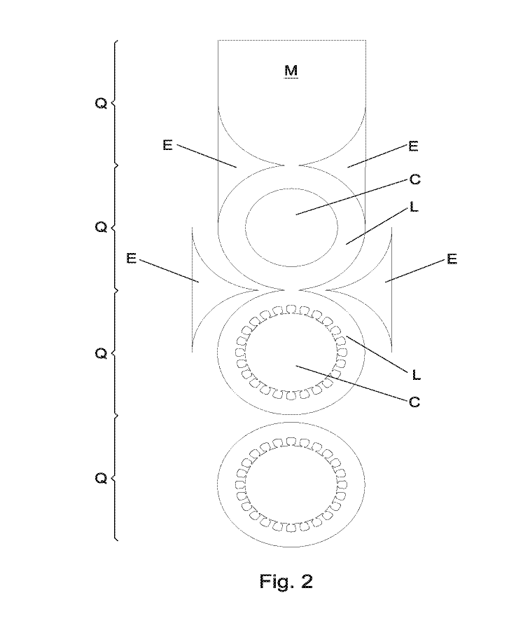

### DETAILED DESCRIPTION OF THE PREFERRED EMBODIMENTS

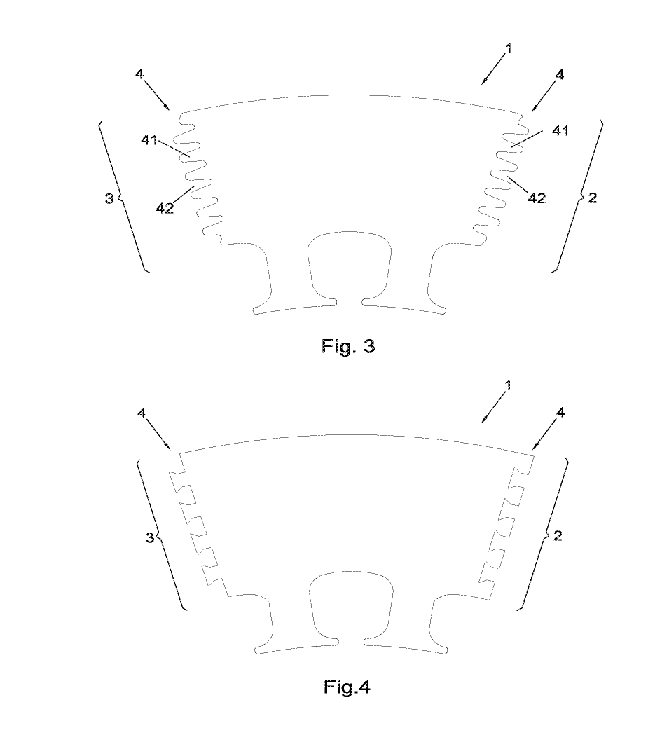

The shaped metallic element of the invention for making the laminations of a stator and/or a rotor of a rotary electric machine or of a laminated ferromagnetic core of a static electric machine is represented as a whole in FIGS. 3 and 4, where it is indicated by 1.

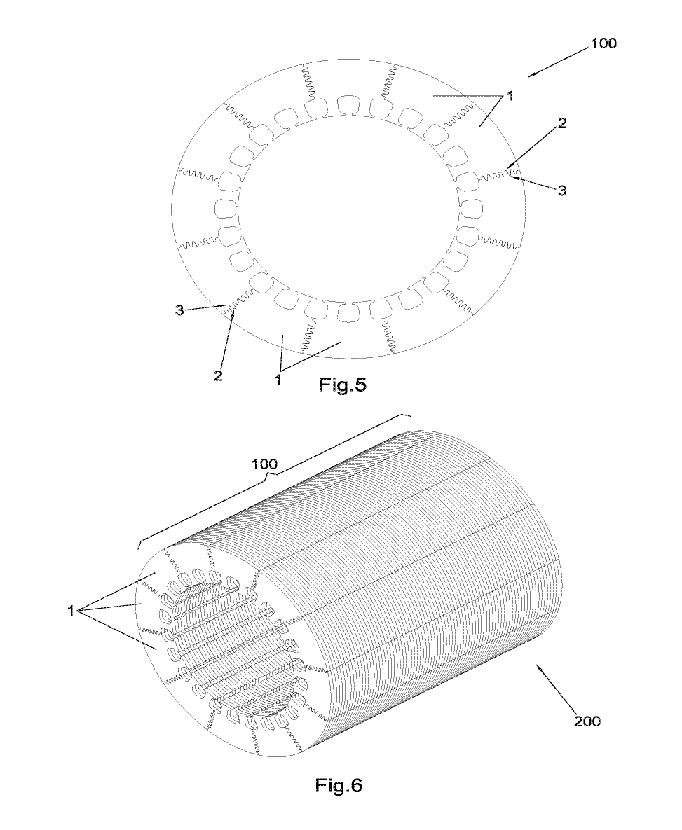

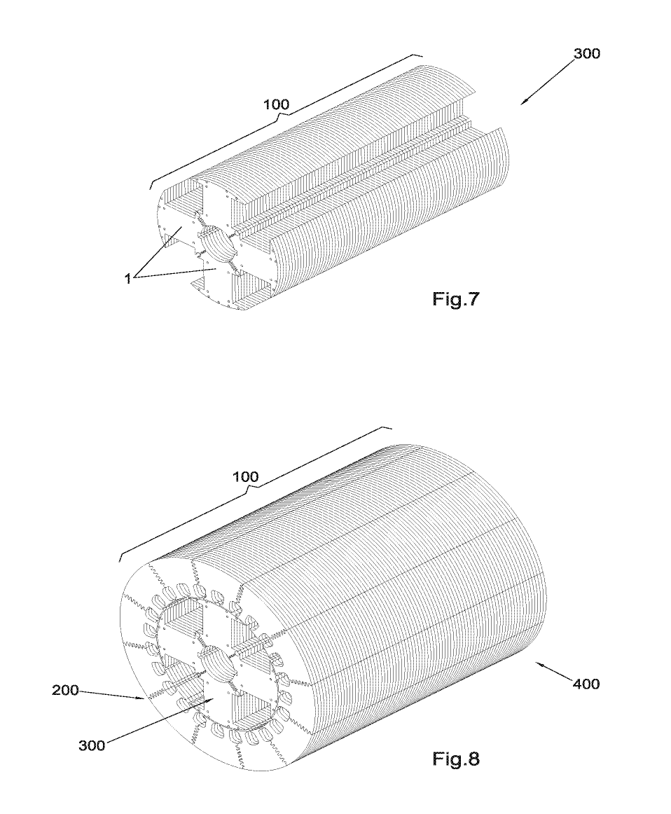

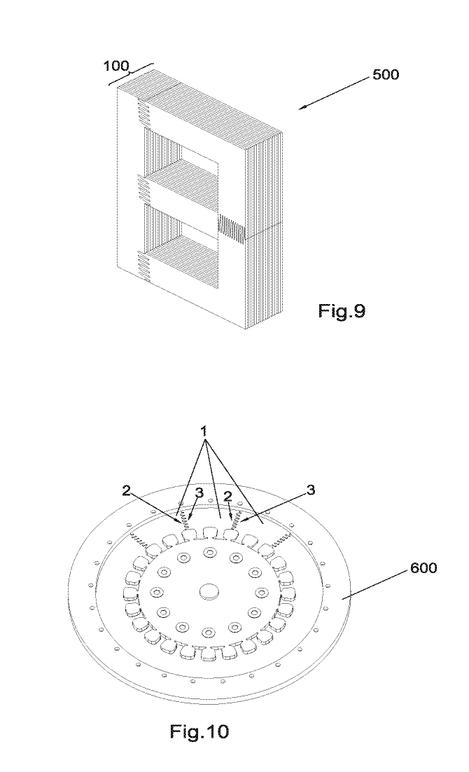

It can be observed that said shaped metallic element 1 is suited to be connected, at the level of two of its sides 2 and 3, to shaped metallic elements 1 of the invention arranged adjacent to it, in such a way as to define a lamination 100 suited to be successively used to make a stator 200 or a rotor 300 of a rotary electric machine 400 or a laminated ferromagnetic core 500 of a static electric machine, respectively shown in FIGS. 5, 6, 7, 8 and 9.

According to the invention, each side 2 and 3 of the shaped metallic element 1 is provided with a shaped profile 4 matching a corresponding side 2 and 3 of the shaped metallic element 1 arranged so that it is adjacent to the first one, so that said shaped metallic elements 1 can be coupled to each other through interference.

Preferably but not necessarily, as shown in FIG. 3, said shaped profile 4 is provided on the entire length of each one of the two sides 2 and 3. Said last characteristic advantageously makes it possible to obtain the coupling through interference along the entire extent of the two sides 2 and 3 of two adjacent shaped metallic elements 1. Consequently, in this situation the percentage value of the magnetic flux loss in said coupling section is negligible compared to a lamination made in a single body.

Furthermore, according to the preferred embodiment of the invention, as can be observed in FIG. 3, each one of said sides 2 and 3 has a matching comb-shaped profile 4.

In greater detail, as can be observed in FIG. 3, said comb-shaped profile is provided with teeth 41 and hollows 42 with a substantially triangular profile.

It is important to underline that the matching shaped profile 4 at the level of the first side 2 of the shaped metallic element 1 is made in such a way that it can exactly match the matching shaped profile 4 provided on the second side 3 of the same shaped metallic element 1.

This advantageously makes it possible to produce shaped metallic elements 1 equal to each other for each individual type of stator, rotor or laminated ferromagnetic core, considerably simplifying the design and production process of said stator, rotor and core.

In an alternative embodiment represented in FIG. 4, the matching shaped profile 4 provided on the first side 2 of the shaped metallic element 1 of the invention has a dovetail profile, while the matching shaped profile 4 of the second side 3 is complementary to and suited to be matched with the dovetail profile of the first side 2.

Also in this case, therefore, each first side 2 of each shaped metallic element 1 can be coupled through interference with each second side 3 of the shaped metallic element 1 arranged so that it is adjacent to the first one.

In further alternative embodiments of the invention, the matching shaped profiles 4 of said sides 2 and 3 can be of a different type compared to those described above, provided that they allow the coupling through interference of the shaped metallic elements 1 arranged so that they are adjacent to each other, thus advantageously avoiding the need to join them using welding techniques.

In this way, therefore, a connection and a direct contact are obtained between each pair of shaped metallic elements 1 over the entire length of the connection area of the sides 2 and 3, as can be observed in FIG. 5.

This advantageously makes it possible to have a minimal loss of magnetic flux along the connection area, while maintaining the efficiency of the stators, rotors and laminated ferromagnetic cores made with said shaped metallic elements very similar to the efficiency of the stators, rotors and laminated ferromagnetic cores made with laminations in a single body.

As mentioned above, the invention concerns also the lamination 100, shown in FIG. 5, for making the stators 200 or rotors 300 of a rotary electric machine 400 and for making the laminated ferromagnetic cores 500 of a static electric machine, obtained by joining through interference a plurality of shaped metallic elements 1 at the level of said sides 2 and 3 with matching shaped profile 4.

The invention includes also the stator 200 and the rotor 300 of a rotary electric machine 400 and the laminated ferromagnetic core 500 of a static electric machine, respectively shown in FIGS. 6, 7 and 9, obtained by stacking a plurality of laminations that in turn are made by joining through interference a plurality of shaped metallic elements 1 according to the invention.

Furthermore, the invention includes also the rotary electric machine 400 shown in FIG. 8, comprising at least the stator 200 or at least the rotor 300, arranged coaxially with each other, and the static electric machine, not illustrated in the figures, comprising the above mentioned ferromagnetic core 500.

Finally, the invention concerns the method and two types of apparatus for making said laminations 100 according to the invention.

In particular, according to the preferred embodiment of the method of the invention, the shaped metallic elements 1 are obtained, through a pressing technique, at the level of the unused portions of a metallic foil from which laminations in a single body are obtained, always by pressing.

However, in an alternative embodiment of the method of the invention, it cannot be excluded that said shaped metallic elements 1 are obtained on a metallic foil specifically used for pressing said elements 1.

In particular, according to said alternative, it is possible to define in an optimal way the position where each individual shaped metallic element 1 is pressed, so as to better exploit the whole surface area of the metallic foil itself.

Successively, according to the method of the invention, as shown in FIG. 10, the shaped metallic elements 1 are arranged in a template 600 comprising a plurality of seats 601 that together define the shape of the stator 200, of the rotor 300 or of the ferromagnetic core 500 to be obtained.

The example of FIG. 10 clearly shows a template 600 for making a stator 200.

Finally, according to the method of the invention, said shaped metallic elements 1, previously arranged in the corresponding seats 601 in the template 600, are fixedly coupled to each other by pressing, in such a way that each side 2 or 3 with matching shaped profile 4 of each shaped metallic element 1 is coupled through interference with the side 2 or 3 of the shaped metallic element 1 arranged so that it is adjacent to it.

In this way, the shaped metallic elements 1 are fixedly constrained to each other, thus forming a lamination that will successively be used to make a stator 200 or a rotor 300 or a laminated ferromagnetic core 500 substantially offering the same performance as a stator, a rotor and a laminated ferromagnetic core made with laminations obtained in a single body.

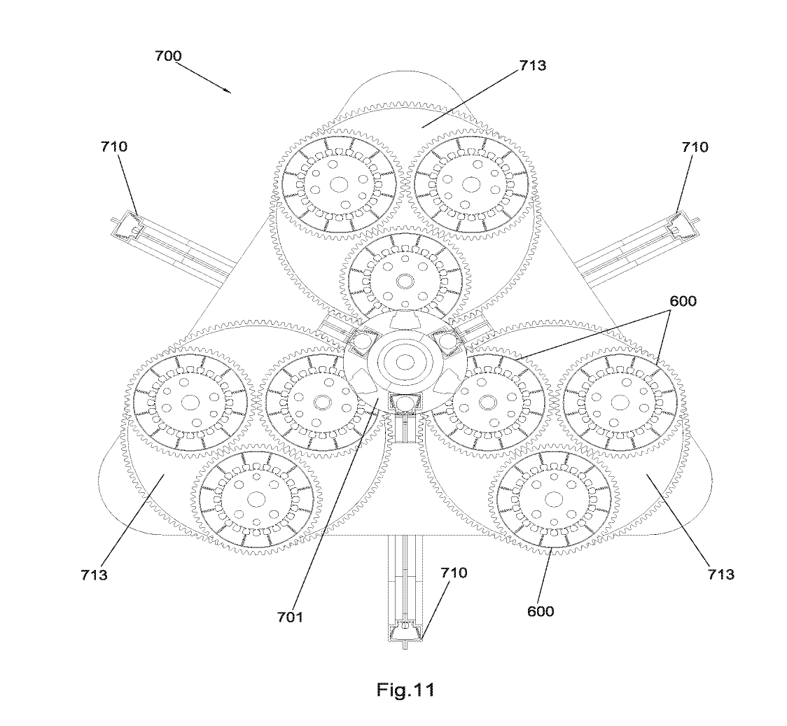

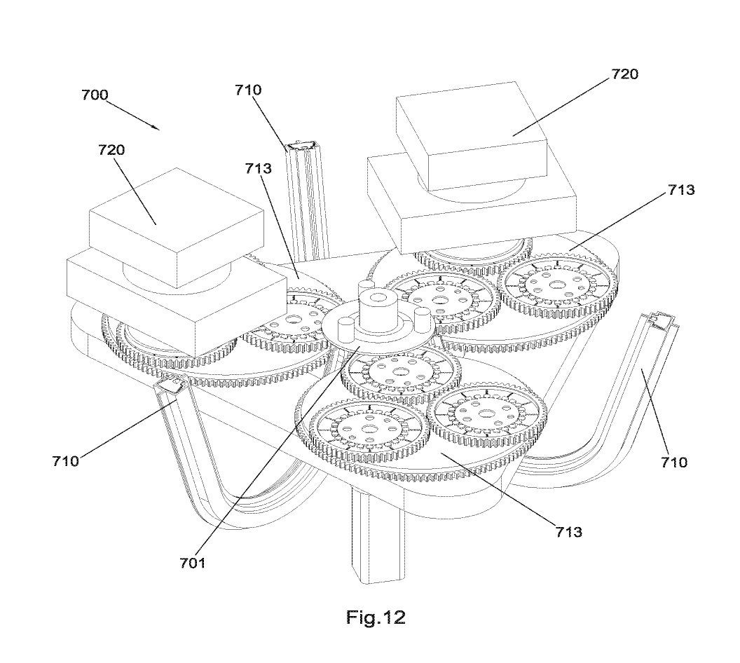

The method of the invention described above is preferably implemented by means of the first type of apparatus 700 for making the laminations 100, said apparatus being also the subject of the invention and being illustrated as a whole in FIGS. 11 and 12.

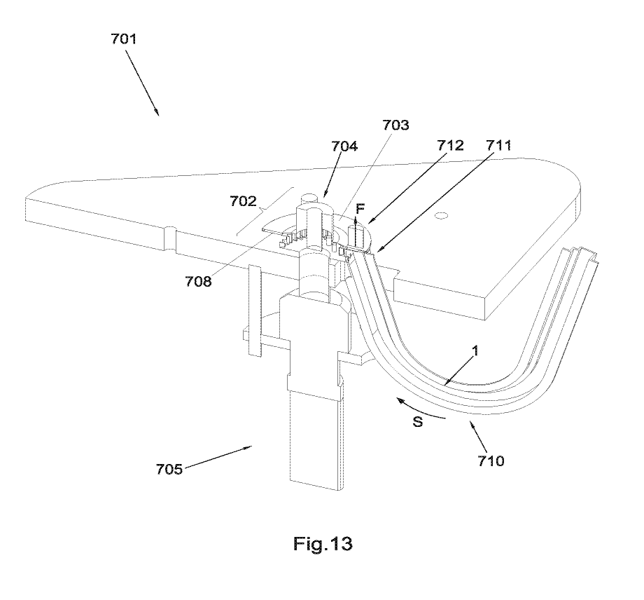

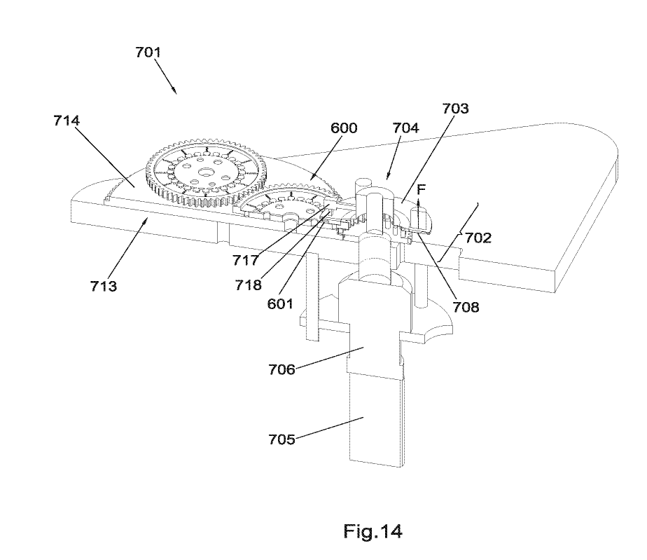

In particular, the apparatus 700 of the invention comprises a loading unit 701, shown in FIGS. 13 and 14 and provided with a first rotary plane 702, called “carousel” in technical jargon, preferably circular in shape and revolvingly coupled with drive means 705 at the level of its centre 704 by means of a transmission shaft 706.

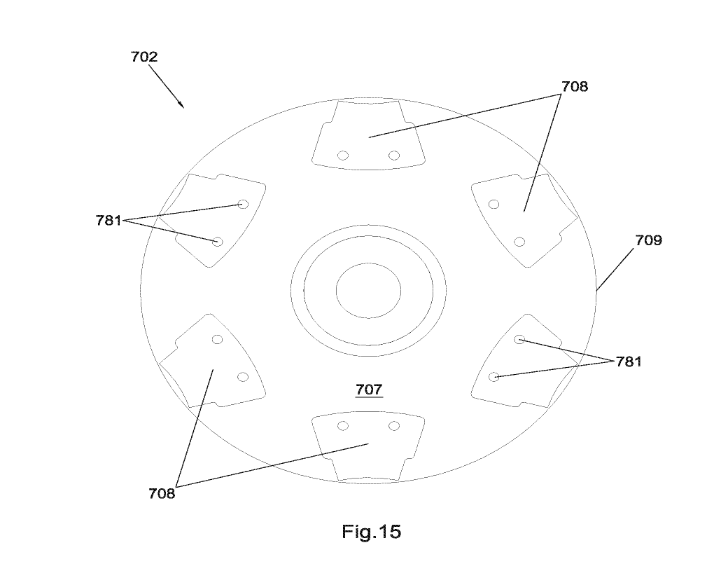

Said first rotary plane 702 is provided, at the level of its underside 707, shown in FIG. 15, with a plurality of housings 708 distributed in sequence close to the perimeter 709 of the same rotary plane 702.

The shape and thickness of said housings 708 are substantially identical to the shape and thickness of said shaped metallic elements 1 of the invention, so that each one of said housings 708 is able to house and hold a single shaped metallic element 1 at a time.

In particular, each one of the housings 708 is provided with locking means 781 suited to hold the shaped metallic element 1 arranged inside it during the rotation of the first rotary plane 702.

In the preferred embodiment of the apparatus that is the subject of the invention, the locking means 781 preferably but not necessarily comprise magnets.

With regard to the drive means 705, these are suited to set the first rotary plane 702 rotating in a discrete way, which is also known as a movement by steps.

In particular, each discrete angular movement of the first rotary plane 702 corresponds to an angular quantity that is equal to the ratio 360°/number of housings 708.

In this way angular positions are defined, at the level of which each housing 708 of the first rotary plane 702 stops for a short time interval.

The loading unit 701 comprises also a conveyor 710, preferably with a U-shaped profile, as shown in FIG. 13, in which a plurality of shaped metallic elements 1 is stored in sequence.

Said conveyor 710 has one of its ends 711 facing the underside 707 of the first rotary plane 702, at the level of a precise angular position, here below referred to as “first angular position”, among said plurality of angular positions.

The end 711 of the conveyor 710 is provided with an opening, so as to allow the outermost shaped metallic element 1 to be extracted from the same conveyor 710.

The loading unit 701 finally comprises magnetic means 712 arranged so that they face the upper side 703 of the first rotary plane 702 at the level of said first angular position, thus on the side opposite the end 711 of the conveyor 710 with respect to the first rotary plane 702, as shown in FIG. 13.

In practice, the components described above, belonging to the loading unit 701, make it possible to collect one shaped metallic element 1 at a time from the end 711 of the conveyor 710, in such a way as to arrange the same element 1 in the free housing 708 that in that specific moment is temporarily stationary in said first angular position.

In particular, in the preferred embodiment described herein, the collection operation is guaranteed both by the thrust S, indicated by the continuous arrow in FIG. 13, to which the outermost shaped metallic element 1 is subjected by the other shaped metallic elements 1 arranged in the conveyor 710, and by the magnetic force F, indicated by the broken-line arrows always in FIG. 13, exerted by the magnetic means 712, which overcomes the force of gravity and any friction, thus attracting said shaped metallic element 1 towards the housing 708.

As explained above, since each housing 708 is provided with its own locking means 781, the shaped metallic element 1 collected in the first angular position is held inside the same housing 708 during the successive rotation steps of the first rotary plane 702.

As is clearly explained below, the first rotary plane 702 is set rotating in such a way as to arrange a shaped metallic element 1 at a time in a corresponding housing 708 for each individual step of the angular rotation.

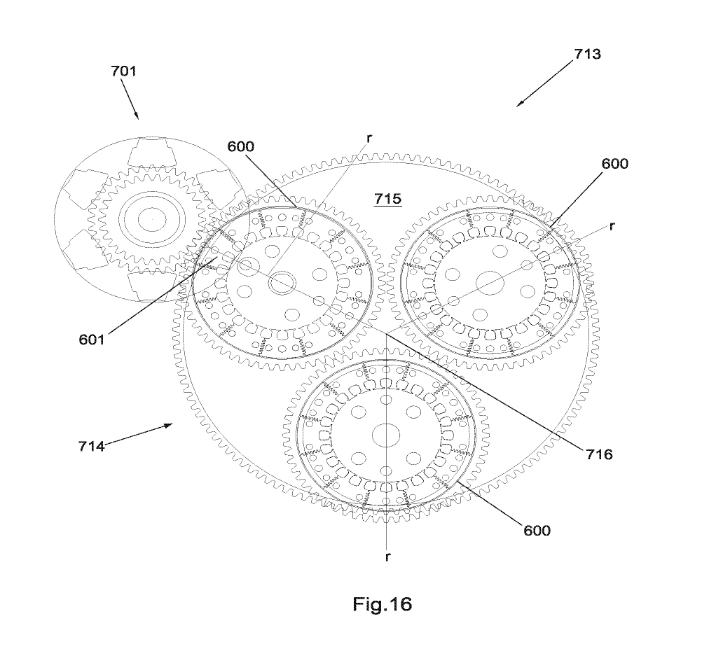

The apparatus 700 of the invention also comprises at least one processing unit 713, shown in FIGS. 14 and 16, including a second rotary plane 714, or “second carousel”, preferably circular in shape, which in turn revolvingly supports on its upper side 715 three templates 600 hinged along the directions defined by three radiuses r of the same rotary plane 714 diverging from one another by 120°, as shown in FIG. 16.

With regard to the second rotary plane 714, this is set rotating in a discrete way, also known as a movement by steps, around its centre 716.

More precisely, the second rotary plane 714 is set rotating so that each one of the templates 600 can temporarily assume three static positions diverging from one another by 120°, which here below are respectively defined as loading position of the template 600, pressing position of the shaped metallic elements 1 and collection position of the lamination 100.

In the apparatus 700 of the invention the first rotary plane 702 of the loading unit 701 and the second rotary plane 714 of the processing unit 713 are coupled with each other in such a way that each housing 708, when it assumes a precise angular position among said plurality of angular positions, indicated here below as second angular position, is exactly superimposed to one of the seats 601 provided in the template 600 that, at the same moment, is in said loading position, as shown in FIG. 11 and in FIG. 14.

In this way, translation means 717 arranged so that they face the upper side 703 of the first rotary plane 702, at the level of the second angular position, as shown in FIG. 14, force the shaped metallic element 1 to exit from the housing 708 and translates towards the underlying seat 601 in the template 600.

Preferably but not necessarily said translation means 717 comprise at least one piston 718 suited to push downwards, and therefore towards said seat 601, the shaped metallic element 1 present in the housing 708, as schematically shown by the arrow in FIG. 14.

Obviously, in order to allow the piston 718, arranged above the first rotary plane 702, to push the shaped metallic element 1 downwards, the first rotary plane 702 must be provided, at the level of each housing 708, with openings suited to allow the piston 718 to pass through said first rotary plane 702.

It cannot be excluded, however, that in alternative embodiments of the apparatus 700 of the invention, said translation means 717 are made in a different manner, provided that they allow the shaped metallic element 1 to be extracted from the housing 708 and to be positioned in the underlying seat 601.

In order to be able to correctly complete the loading operation of the entire template 600 arranged in the loading position, the same template 600 and the first rotary plane 702 are set rotating in a synchronized manner, so that each angular movement of the first rotary plane 702 is accompanied by a corresponding angular movement of the template 600.

Consequently, for each housing 708 arranged at the level of the second angular position and accommodating a shaped metallic element 1 there is an underlying seat 601 in the template 600 where said shaped metallic element 1 can be positioned.

Obviously, each operation of translation of a shaped metallic element 1 from the respective housing 708, arranged at the level of the second angular position, towards the template 600, takes place at the same time as the operation of loading another shaped metallic element 1 in a housing 708 that is in the first angular position, in the manner explained above.

When the template 600 has been completely filled with a plurality of shaped metallic elements 1, the second rotary plane 714 of the processing unit 713 is rotated by 120° so that the same template 600 assumes the above mentioned pressing position.

The apparatus 700 of the invention, in fact, comprises, at the level of the pressing position, pressing means 720, schematically represented in FIG. 12, suited to force the coupling by interference of the shaped metallic elements 1 into the template 600, thus implementing the pressing step of the method of the invention.

Simultaneously with said pressing operation, the apparatus 700 of the invention provides, in the manner described above, for loading the shaped metallic elements 1 on the template 600 of the processing unit 713 presently arranged in the loading position.

When the loading and pressing operations in the respective templates 600 have been completed, the second rotary plane 714 is rotated by 120° again, so that the template 600, on which the pressing operation has been carried out, is arranged in the collection position, at the level of which the completed lamination 100 is collected.

Preferably but not necessarily, the collection of the lamination 100 takes place through collection means that are external to the apparatus 700 of the invention.

However, it cannot be excluded that in alternative embodiments of the invention said collection means belong to the apparatus 700.

Furthermore, the preferred embodiment of the apparatus 700 of the invention comprises three processing units 713, as shown in FIGS. 11 and 12, arranged so that they diverge from one another by 120° with respect to the centre 704 of the first rotary plane 702 of the loading unit 701.

In this case the loading unit 701 includes a conveyor 710, magnetic means 712 and translation means 717 for each one of said three processing units 713.

Furthermore, a first and a second angular position will be defined for each one of said three processing units 713.

However, it cannot be excluded that in different embodiments of the apparatus 700 of the invention the above mentioned processing units 713 are present in a number different from three.

In the preferred embodiment of the invention the drive means 705 of the loading unit 701 are suited to move, through suitable transmission means not illustrated in the figures, also the templates 600 arranged in the loading position of each one of the processing units 713.

Also in this case, it cannot be excluded that in alternative embodiments of the apparatus 700 of the invention the drive means suited to move the templates 600 in the loading position are distinct from the drive means 705 belonging to the loading unit 701.

In addition to the first type of apparatus 700 just described above, the invention includes also a second type of apparatus for making said laminations 100. The characteristics of said second type of apparatus of the invention, indicated in Figures from 17 to 19 by reference number 800, are described in detail here below.

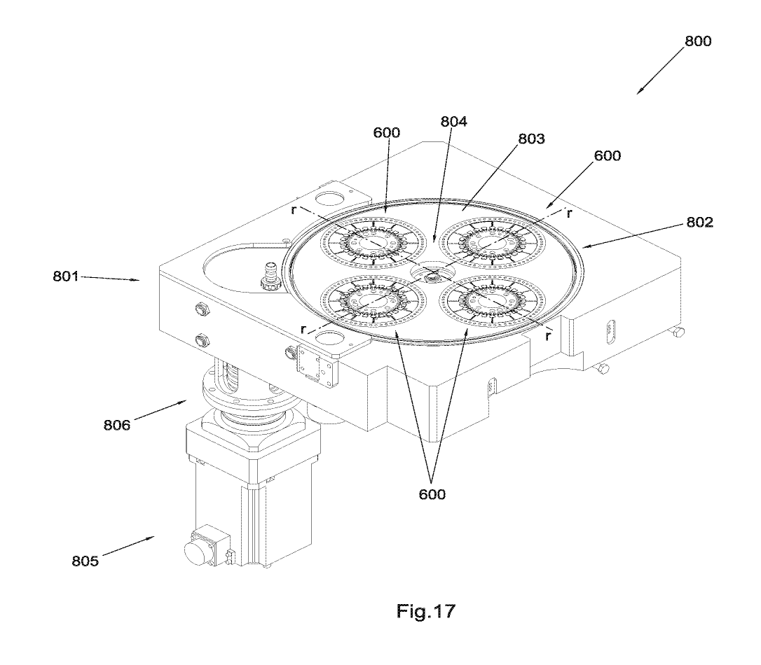

With reference to FIG. 17, it can be observed that the apparatus 800 of the invention, as well as the apparatus 700, comprises a processing unit 801, provided with a rotary plane 802, called “carousel” in technical jargon, preferably circular in shape and revolvingly coupled with drive means 805 through a transmission shaft 806.

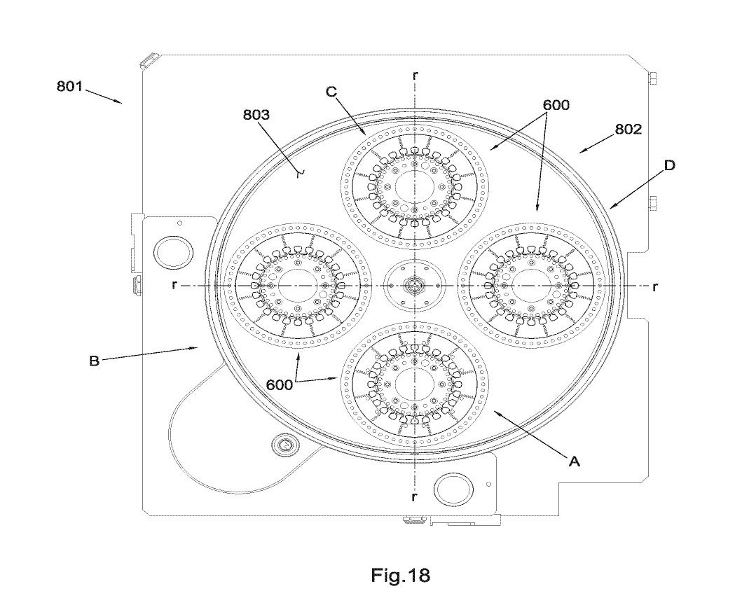

In particular, according to the preferred embodiment described herein, as shown in FIG. 18, said rotary plane 802 supports on its upper side 803, preferably but not necessarily, four templates 600 arranged along four radiuses r of the same plane 802 diverging from one another by 90°.

Said rotary plane 802 of the processing unit 801 is configured so as to be set rotating around its centre 804 in a discrete manner, so that each template 600 can temporarily assume four static positions diverging from one another by 90°, here below respectively defined first loading position of the template 600 (indicated by A in FIG. 18), second loading position of the template 600 (position B), pressing position C of the shaped elements 1 and collection position D of the lamination 100.

It cannot be excluded, however, that in different embodiments of said second type of apparatus 800 of the invention the number of said loading positions is higher than two and, consequently, the number n of templates 600 arranged on the upper side of the rotary plane 802 and the number n of overall static positions that each one of said templates 600 can assume on the rotary plane 802 is higher than four.

In particular, the n radiuses r of said rotary plane 802 at the level of which the templates 600 are arranged and, furthermore, the n static positions that each template 600 can assume diverge from one another by an angle equal to 360°/n.

In general, said second type of apparatus 800 of the invention includes, for the reasons that will be explained here below, the presence of at least two loading positions, one pressing position and one collection position.

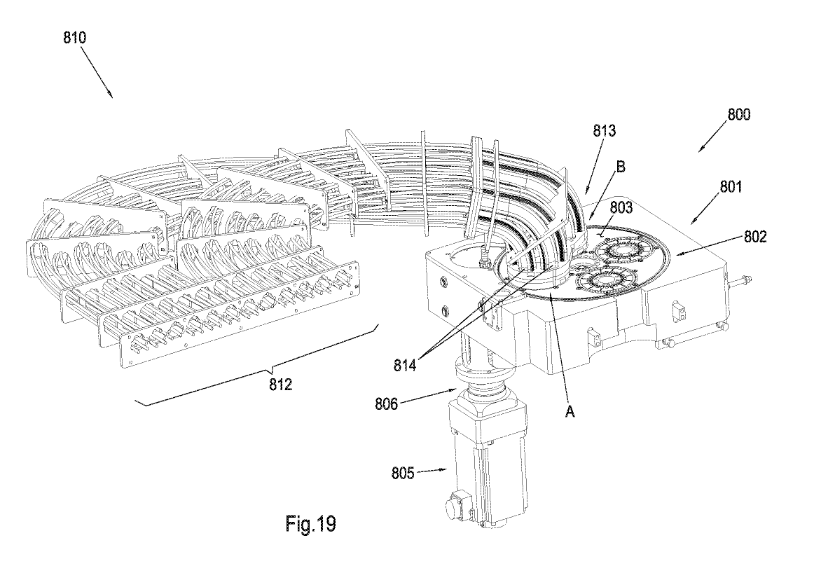

With regard, again, to the preferred embodiment of the apparatus 800, as shown in FIG. 19, it also comprises a loading unit 810 provided with a storage unit, not illustrated in the figures, suited to contain a plurality of said shaped elements 1. A plurality of conveyors 812, illustrated in FIG. 19, is operatively connected to said storage unit. Each one of said conveyors 812 also has its distal end 813, with respect to the storage unit, facing the upper side 803 of said rotary plane 802, at the level of one of the two loading positions A or B. In detail, at the level of said ends 813, the conveyors 812 are provided with an opening 814, so that the shaped metallic elements 1 are transported, in sequence, by each conveyor 812 from said storage unit to a specific seat 601 provided in one of the two templates 600 arranged in the first or in the second loading position A and B. In particular, each conveyor 812, belonging to said plurality of conveyors 812, is arranged in such a way that it has its opening 814 facing over a specific seat 601 distinct from the other seats 601 over which the openings 814 of the other conveyors 812 are facing, so that when a template 600 passes beyond both the loading positions A and B, in all said seats 601 there is a single shaped metallic element 1.

According to the preferred embodiment of the apparatus 800 of the invention shown in FIG. 19, in which each template 600 comprises twelve of said seats 601 for the shaped metallic elements 1, as clearly shown in FIG. 18, the loading unit 810 in turn comprises twelve conveyors 812, six of which have their distal ends 813 facing six seats 601 provided in a template 600, when said template is arranged in the first loading position A.

Regarding the other six conveyors 812, as shown always in FIG. 19, they have their distal ends 813 facing the remaining six seats 601 remained empty of the same template 600, when the latter is arranged at the level of the second loading position B.

In even greater detail, according to the preferred embodiment of the apparatus 800 of the invention, the first six conveyors 812 are suited to arrange the shaped metallic elements 1 at the level of a first group of seats 601 of the template 600 that are spaced from one another by other seats not belonging to said first group.

In other words, in the case where the template 600 has twelve seats 601, as in the preferred embodiment described herein, said conveyors 812 are configured, for example, in such a way as to arrange the shaped metallic elements 1 at the level of the group of seats 601 comprising the first, the third, the fifth, the seventh, the ninth and the eleventh seat. In this case, therefore, each seat 601 belonging to the first group is spaced from the other seats 601 of the same group by a seat 601 that is temporarily left free.

In the same way, in the second loading position B, the conveyors 812 are configured so as to arrange the shaped metallic elements 1 at the level of a second group of seats 601 of the template 600 that are spaced from one another and free after the completion of the first loading operation carried out at the level of the first loading position A.

In practice, referring again to the previous example, the conveyors 812 will arrange the shaped metallic elements 1 at the level of the second group of seats 601 comprising the second, the fourth, the sixth, the eighth, the tenth and the twelfth seat.

In this case, therefore, each seat 601 belonging to the second group is spaced from the seats 601 of the same group by a seat 601 that is already provided with a shaped metallic element 1.

In this way, the shaped metallic elements 1 are arranged in the template 600 through the first and the second loading operation, on two different levels.

Said arrangement on two levels is necessary because the shaped metallic elements 1 are configured, as explained above, so that they can be coupled with each other through interference by means of a pressing operation. Therefore, at the moment when said shaped metallic elements 1 are arranged in two adjacent seats 601 in the template 600, their sides 2 and 3 with shaped profile 4 are superimposed to each other. Therefore, it would be extremely difficult to arrange shaped metallic elements 1 on adjacent seats 601 in the template 600 at the same moment, or at least their simultaneous positioning may determine a mutual position of said shaped metallic elements 1 that is not suitable for allowing the successive pressing operation to be performed.

In the alternative embodiments of the apparatus 800 of the invention in which the number of loading positions is higher than two the loading principle remains the same. In particular, for each loading position the corresponding conveyors 812 are suited to arrange the shaped metallic elements 1 at the level of a group of seats 601 spaced from one another.

In particular, differently from the preferred embodiment described herein, there may be several seats 601 interposed between two seats 601 in which the shaped metallic elements 1 are loaded at the same moment.

The arrangement of each individual shaped metallic element 1 in a specific seat 601 of the template 600, at the level of one of the loading positions, is preferably but not necessarily guaranteed by the fact that the thickness of said seat 601 substantially corresponds to the thickness of the same shaped metallic element 1. In this way, when the shaped metallic element 1 is arranged in one of said seats 601, the upper side of the same is substantially coplanar with the upper side of the template 600. Therefore, only the shaped metallic element 1 inserted in the seat 601, among the plurality of shaped metallic elements 1 arranged in sequence on a conveyor 812, is translated together with the template 600 through the rotation of the rotary plane 802, while the other shaped metallic elements 1 remain in said conveyor 812. In order to obtain the same result also at the level of the second loading position B, it is necessary, during the translation of the template 600 from the first loading position A to said second loading position B, to lower the bottom of the template 600 with respect to its upper side. In this way it is possible to define a space, among the shaped metallic elements 1 already positioned in the template 600 in said first loading position A and the upper side of the template 600, the thickness of said space substantially corresponding to the thickness of a shaped metallic element 1. Therefore, even in the second loading position B, the individual shaped metallic element 1 inserted in a still empty seat 601 will rest, with its sides 2 and 3, against the sides 2 and 3 of the adjacent shaped metallic elements 1 already inserted at the level of the first loading position A. For this reason, the shaped metallic element 1 inserted at the level of the second loading position B will have its upper side substantially coplanar with the upper side of the template 600. Therefore, also in this case, only the shaped metallic elements 1 inserted in the free seats 601 during the second loading operation are translated together with the template 600, when the rotary plane 802 is set rotating, while the other shaped metallic elements 1 remain on the corresponding conveyor 812.

The lowering and successive raising of the bottom of the template 600 during the translation of the same in the various loading positions A and B are made possible by cam means positioned at the level of the underside of the rotary plane 802 and mechanically cooperating with the templates 600.

As in the case of the first type of apparatus 700 of the invention, also for said second type of apparatus 800, when the template 600 is completely filled with a plurality of shaped metallic elements 1, the rotary plane 802 of the processing unit 801 is rotated by 90° so that the same template 600 assumes said pressing position C, indicated in FIG. 18.

The apparatus 800 of the invention, in fact, comprises, at the level of the pressing position C, pressing means, not represented in the figures, suited to force the coupling through interference of the shaped metallic elements 1 inside the template 600, thus performing the pressing step of the method that is the subject of the invention.

Simultaneously with said pressing operation, the apparatus 800 of the invention provides for loading, in the manner described above, the shaped metallic elements 1 on the templates 600 of the processing unit 801 that are presently arranged in the first and second loading position A and B.

When the loading and pressing operations in the corresponding templates 600 have been completed, the rotary plane 802 is again rotated by 90° so that the template 600, on which the pressing operation has been carried out, is arranged in the collection position D, at the level of which the completed lamination 100 is collected.

The collection of the lamination 100 is preferably but not necessarily carried out through collection means that are external to the apparatus 800 of the invention.

According to the above, it can thus be understood that the shaped metallic element that is the subject of the invention achieves all the set objects.

In particular, the invention achieves the object to provide shaped metallic elements that when joined to one another make it possible to obtain laminations whose efficiency is just a few percentage points lower than the efficiency of the laminations made in a single body.

For this reason, the invention also achieves the object to provide shaped metallic elements that make it possible to obtain laminations suited to be used to make the main stator and/or rotor of the rotary electric machine and not only laminations for the stator and rotor of the exciting device.

The invention furthermore achieves the object to obtain the shaped metallic elements from portions of a metallic foil that were previously considered scrap material.

Consequently, the invention also achieves the object to make shaped metallic elements that make it possible to reduce the production costs of the rotors and stators of rotary electric machines.

In the construction stage, the shaped metallic element of the invention, the lamination, the stator, the rotor, the laminated ferromagnetic core, the rotary electric machine and the static electric machine of the invention, and finally the method and the two types of apparatus for making said laminations of the invention can be subjected to changes that, although not illustrated and not described herein, must all be considered protected by the present patent, provided that they fall within the scope of the following claims.

Where technical features mentioned in any claim are followed by reference signs, those reference signs have been included for the sole purpose of increasing the intelligibility of the claims and accordingly such reference signs do not have any limiting effect on the protection of each element identified by way of example by such reference signs.

What is claimed is:

1. Shaped metallic element (1) for making laminations (100) for a stator (200) and/or a rotor (300) of a rotary electric machine (400) or for a laminated ferromagnetic core (500) of a static electric machine, of the type comprising at least two sides (2, 3) suited to be fixedly joined to corresponding sides (2, 3) of at least two shaped metallic elements (1) arranged so that they are adjacent to said shaped metallic element (1), wherein said at least two sides (2, 3) have a shaped profile (4) matching the shaped profile of the sides (2, 3) of the adjacent shaped metallic elements (1) so that said shaped metallic elements (1) can be fixedly coupled with each other through interference.

2. Shaped metallic element according to claim 1, wherein said matching shaped profile (4) obtained on each one of said sides (2, 3) is a comb-shaped profile.

3. Shaped metallic element according to claim 1, wherein said matching shaped profile (4) obtained on a first one of said sides (2, 3) of said shaped metallic element (1) is a dovetail profile and the matching shaped profile (4) of the second one of said sides (2, 3) is complementary to the dovetail profile (4) defined on said first side (2, 3).

4. Shaped metallic element according to claim 1, wherein said shaped profile (4) is provided on the entire length of said two sides (2, 3).

5. Lamination (100) for making stators (200) or rotors (300) of a rotary electric machine (400) or for making a laminated ferromagnetic core (500) of a static electric machine, comprising a plurality of said shaped metallic elements (1) coupled with each other through interference at the level of said matching shaped sides (2, 3).

6. Stator (200) of a rotary electric machine (400) of the type comprising a plurality of laminations (100) stacked on one another, wherein said laminations (100) are of the type according to claim 5.

7. Rotor (300) of a rotary electric machine (400) of the type comprising a plurality of laminations (100) stacked on one another, wherein said laminations (100) are of the type according to claim 5.

8. Rotary electric machine (400) of the type comprising a stator and a rotor arranged coaxial with each other, wherein said stator (200) is of the type according to claim 6.

9. Rotary electric machine (400) of the type comprising a stator and a rotor arranged coaxial with each other, wherein said rotor (300) is of the type according to claim 7.

10. Laminated ferromagnetic core (500) of a static electric machine of the type comprising a plurality of laminations (100) stacked on one another, wherein said laminations (100) are of the type according to claim 5.

11. Static electric machine of the type comprising a laminated ferromagnetic core (500), wherein said laminated ferromagnetic core (500) is of the type according to claim 10.

12. Method for making a lamination (100) for making stators (200) or rotors (300) of a rotary electric machine (400) or for making a laminated ferromagnetic core (500) of a static electric machine, the method comprising the steps of:
arranging a plurality of shaped metallic elements (1) of the type according to claim 1, in a template (600) that reproduces the shape of said stator (200) or of said rotor (300) or of the laminated ferromagnetic core (500);
pressing said shaped metallic elements (1) arranged in said template (600) so that the sides (2, 3) of said adjacent shaped metallic elements (1) are coupled with each other through interference.

13. Apparatus (700) for making a lamination (100) of the type according to claim 5, comprising:
a loading unit (701) provided with a first rotary plane (702), preferably circular in shape, revolvingly coupled with drive means (705) at the level of its centre (704) by way of a transmission shaft (706), said first rotary plane (702) being provided, at the level of its underside (707), with a plurality of housings (708) distributed in sequence close to its perimeter (709) and suited to house and hold a shaped metallic element (1), said first rotary plane (702) being furthermore suited to be set rotating in a discrete way by said drive means (705) in such a way as to define a plurality of angular positions at the level of which each one of said housings (708) is suited to stop temporarily, said angular positions comprising a first angular position in which said shaped metallic element (1) is loaded in one of said housings (708) and a second angular position at the level of which said shaped metallic element (1) is unloaded from said housing (708);
at least one processing unit (713) provided with a second rotary plane (714), which revolvingly supports on its upper side (715) three templates (600) hinged along the directions defined by three radiuses (r) of said second rotary plane (714) diverging from one another by 120°, said second rotary plane (714) being suited to be set rotating in a discrete way so that each one of said templates (600) is suited to temporarily assume three static positions diverging from one another by 120° and defined as the loading position of the template (600), the pressing position of the shaped metallic elements (1) and the collection position of the lamination (100);
said first rotary plane (702) of said loading unit (701) and said second rotary plane (714) of said processing unit (713) being mutually coupled so that each one of said housings (708), when it assumes said second angular position, is superimposed to a seat (601) provided in said template (600) arranged, at the same instant, in said loading position.

14. Apparatus (800) for making a lamination (100) of the type according to claim 5, the apparatus comprising:
a processing unit (801), provided with a rotary plane (802), preferably circular in shape, revolvingly coupled with drive means (805) through a transmission shaft (806), said rotary plane (802) being provided, at the level of its upper side (803), with at least four templates (600) arranged along the directions defined by four radiuses (r) of said rotary plane (802) diverging from one another by 90°, said rotary plane (802) being suited to be set rotating in a discrete manner, so that each one of said four templates (600) can temporarily assume four static positions diverging from one another by 90°, defined first loading position (A) of said template (600), second loading position (B) of said template (600), pressing position (C) of the shaped metallic elements (1) and collection position (D) of said lamination (100);
a loading unit (810) comprising a storage unit suited to contain a plurality of said shaped elements (1) and a plurality of conveyors (812) operatively connected to said storage unit, each one of said conveyors (812) having, at the level of its distal end (813) with respect to said storage unit, an opening (814) that faces a specific seat (601), distinct from the other seats (601), provided in one of the two templates (600) arranged at the level of said first or of said second loading position (A, B), so that when a template (600) passes beyond both said two loading positions (A, B), there is a single shaped metallic element (1) in all its seats (601).
